(19) United States
(12) Patent Application Publication
(10) Pub. No.: US 2008/0228788 A1
(43) Pub. Date: Sep. 18, 2008

(54) INFORMATION PROCESSING APPARATUS, METHOD, AND RECORDING MEDIUM

(75) Inventor: Takayuki Kaneko, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/044,824

(22) Filed: Mar. 7, 2008

(30) Foreign Application Priority Data
Mar. 16, 2007 (JP) 2007-068791

(51) Int. Cl. G06F 17/30

(52) U.S. Cl. 707/100; 707/E17.009

(57) ABSTRACT

A method manages a data to which storage expiration is set, in a case where the data is returned to an original apparatus after transferring the data to another apparatus for back-up. The method includes selectively performing a first process for storing data read from a first storage unit, in a second storage unit, and a second process for storing the data stored in the second storage unit by the first process in the first storage unit, and invalidating the data stored in a first storage unit by the second process based on a predetermined period from performance of the first process to storage expiration indicated by the storage expiration information previously set to the data read out by the first process, in a case where a data stored in the second storage unit by the first process is stored in the first storage unit by the second process.

### BACKGROUND OF THE INVENTION

1. Field of the Invention

The present invention relates to an information processing apparatus, method, and storage medium.

2. Description of the Related Art

Recently, there is an information processing apparatus that includes a scanner and a printer to realize a copy function, and that connects to a network to realize a data transmission function. Further, the information processing apparatus includes a memory such as a hard disk to realize a file processing function. By using such a file processing function, a user can store an image data that is input from the scanner in a memory as a file, and print the stored file at any given time.

Moreover, the above-described information processing apparatus may implement a system which groups together a number of files that are stored in a memory. The system may set storage expiration to the group of files to make effective use of a memory in the information processing apparatus (refer to Japanese patent application Laid-Open No. 2004-266456). Such a system may manage the storage expiration of a file stored in a memory of the system and deletes files that have exceeded the storage expiration.

Furthermore, in recent years, there is a method of backing up a file stored in a memory of an information processing apparatus to other recording medium to prevent loss of a file. By using such a backup method, a user can, for example, back up a file stored in an information processing apparatus to an external recording medium and can later restore the backed up file to the original information processing apparatus.

However, the above-described conventional methods have problems as described below. For example, a file that belongs to a group whose storage expiration is Apr. 21, 2006 may exceed the storage expiration while the file is backed up to another storage medium. In such a case, if the backed up file is restored in the original information processing apparatus, the information processing apparatus attempts to restore the file to the original group. However, since storage expiration of Apr. 21, 2006 is set to the group, the restored file is subject to deletion. Therefore, the information processing apparatus may determine that the file has exceeded the storage expiration and delete the restored file.

On the contrary, if the restored file is stored in an area to which storage expiration is not set, the file can be retained in a memory after the file exceeds the storage expiration. In such a case, the file may be stored in the memory longer than necessary, which is not favorable in terms of security, or in making an effective use of the memory.

### SUMMARY OF THE INVENTION

An embodiment of the present invention is directed to an information processing apparatus that appropriately manages storage expiration which is set to a data, in a case where the data is restored after transferring the data to another storage device to back up the data.

According to an aspect of the present invention, an apparatus includes a control unit configured to invalidate data stored in a first storage unit based on storage expiration information of the data, and a memory control unit configured to selectively perform a first process for storing data read from the first storage unit in a second storage unit, and a second process for storing the data stored in the second storage unit by the first process, in the first storage unit, wherein the control unit invalidates the data stored in the first storage unit based on a predetermined period from performance of the first process to storage expiration indicated by the storage expiration information, in a case where data stored in the second storage unit by the first process is stored in the first storage unit by the second process.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a system configuration of an image processing system according to an exemplary embodiment of the present invention.

FIG. 2 illustrates a hardware configuration of a server computer according to an exemplary embodiment of the present invention.

FIG. 3 illustrates a hardware configuration of an image processing apparatus according to an exemplary embodiment of the present invention.

FIG. 4 illustrates an operation unit of an image processing apparatus according to an exemplary embodiment of the present invention.

FIG. 5 illustrates an example of a screen that is displayed on a touch panel unit according to an exemplary embodiment of the present invention.

FIG. 6 illustrates an example of a screen that is displayed on a touch panel unit according to an exemplary embodiment of the present invention.

FIG. 7 illustrates an example of a screen that is displayed on a touch panel unit according to an exemplary embodiment of the present invention.

FIG. 8 illustrates an example of a screen that is displayed on a touch panel unit according to an exemplary embodiment of the present invention.

FIG. 9 illustrates an example of a screen that is displayed on a touch panel unit according to an exemplary embodiment of the present invention.

FIG. 10 illustrates attribute data according to an exemplary embodiment of the present invention.

FIG. 11 illustrates attribute data according to an exemplary embodiment of the present invention.

FIG. 12 is a flowchart illustrating an example of control procedures according to an exemplary embodiment of the present invention.

FIG. 13 is a flowchart illustrating an example of control procedures according to an exemplary embodiment of the present invention.

FIG. 14 is a flowchart illustrating an example of control procedures according to an exemplary embodiment of the present invention.

FIG. 15 is a flowchart illustrating an example of control procedures according to an exemplary embodiment of the present invention.

FIG. 16 illustrates a program code group according to an exemplary embodiment of the present invention.

FIG. 17 illustrates a method of calculating new storage expiration according to an exemplary embodiment of the present invention.

FIG. 18 illustrates a method of calculating new storage expiration according to an exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

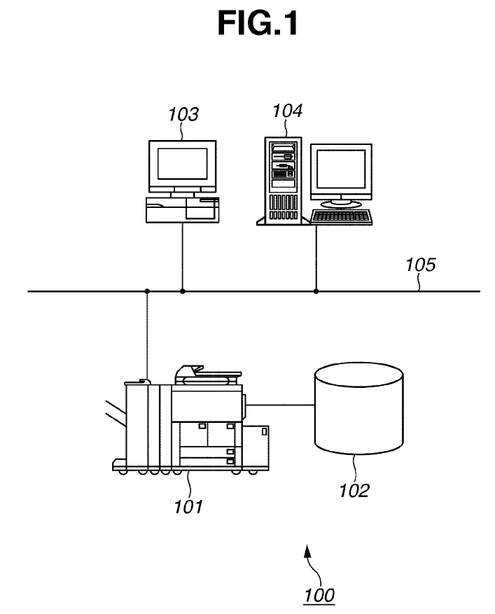

FIG. 1 illustrates a system configuration of an image processing system 1000 according to an exemplary embodiment of the present invention.

Referring to FIG. 1, the image processing system 1000 includes an image processing apparatus 101, an external storage medium 102, a client computer 103, and a sever computer 104. The above-described apparatuses are connected via a network 105.

The image processing apparatus 101 prints an image that is read by an image reading unit included in the image processing apparatus 101. Further, the image processing apparatus 101 receives an image data transmitted from the client computer 103 or the sever computer 104 that are connected via the network 105, and prints the received image data on a recording medium such as a printing paper.

Further, the image processing apparatus 101 can store image data that is read by the image reading unit or received via the network 105. The image processing apparatus 101 can later print or send the stored image data according to a user instruction.

A data stored in the image processing apparatus 101 is backed up to the external storage medium 102. Further, the backup data stored in the external storage medium 102 is restored to the image processing apparatus 101. Examples of the external storage medium 102 that stores backup data are hard disk, universal serial bus (USB) memory, floppy disk, compact disk readable (CD-R), and digital versatile disk-recordable (DVD-R). Additionally, backup data can be stored in any image processing apparatus or information processing apparatus that includes the external storage medium 102 and can store data of the image processing apparatus 101.

The client computer 103 creates and edits image data. The client computer 103 sends the image data to the server computer 104 or to the image processing apparatus 101 via the network 105.

The server computer 104 can communicate with the image processing apparatus 101 and the client computer 103 via the network 105. For example, the server computer 104 can receive data stored in the image processing apparatus 101 via the network 105 and back up the data. Further, the server computer 104 can restore the backup data stored in the server computer 104 to the image processing apparatus 101.

In the present exemplary embodiment, “back up” is defined as reading out a specific data stored in a storage area and storing the data in a storage area other than the original storage area (such as the above-described external storage medium 102 or the server computer 104). Further, a “backup source” is defined as a storage area from which a data is read out, and a “backup destination” is a storage area in which a data is stored. A data can be backed up by reading out the data from the backup source and storing the data in a backup destination. Moreover, a copy of a data in a backup source can be read out from the backup source and stored in a backup destination. A data to be backed up can be electronically compressed to save amount of memory, or can be encrypted for security reasons. Thus, a user of an image processing apparatus can prepare for data corruption or a computer virus infection by backing up data.

In the present exemplary embodiment, “restore” is defined as reading out a data that is backed up in a storage area of a backup destination and storing the data to a storage area of a backup source. A data can be restored by reading out the data itself from the backup destination and storing the data in a backup source, or by reading out a copy of a data from the backup destination and storing the data in a backup source. Further, in a case where backup data is compressed and stored, the data is decompressed and restored. Moreover, if a backup data is encrypted and stored in a backup destination, the data is decrypted and restored in a backup source. Further, a data of an image processing apparatus that is backed up can be restored in a different image processing apparatus.

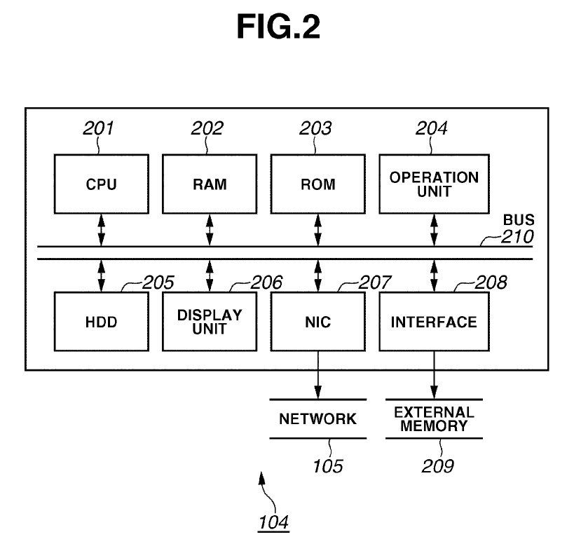

FIG. 2 illustrates an internal configuration of the server computer 104.

The server computer 104 includes a central processing unit (CPU) 201, a random access memory (RAM) 202, a read-only memory (ROM) 203, an operation unit 204, a hard disk drive (HDD) 205, a display unit 206, a network interface card (NIC) 207, an interface 208, and external memory 209. The above devices are connected via a bus 210.

The CPU 201 performs various control according to a program stored in the ROM 203. The RAM 202 is used as a work area of the CPU 201.

The ROM 203 stores various programs that the CPU 201 reads out and uses.

The CPU 201 receives user instruction through the operation unit 204. Examples of the operation unit 204 are a keyboard and a mouse.

The HDD 205 is a hard disk for storing backup data sent from the image processing apparatus 101.

The display unit 206 displays a setting screen or a warning to a user. Examples of the display unit 206 are a cathode ray tube (CRT) and a liquid crystal display (CLD).

The NIC 207 is used to exchange data with the image processing apparatus 101 and the client computer 103 via the network 105. The external memory 209 stores data received through the interface 208.

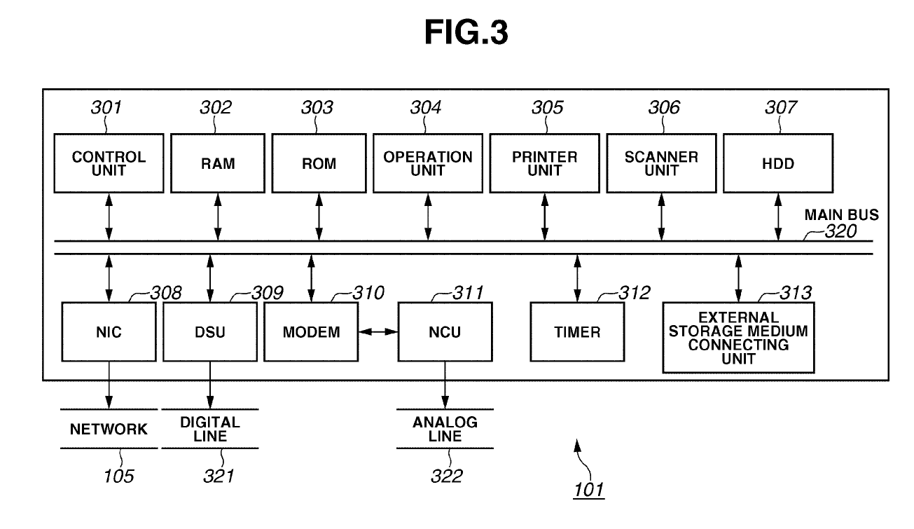

FIG. 3 illustrates an internal configuration of the image processing apparatus 101.

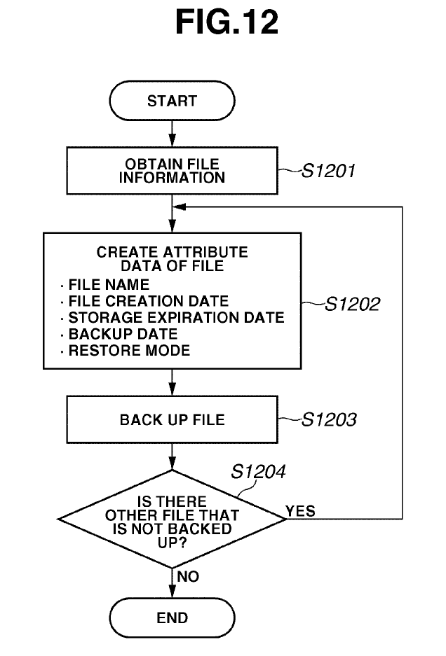

A control unit 301 reads an original image using a scanner unit 306 and prints the read image data using a printer unit 305 according to a program stored in a ROM 303. The control unit 301 can further store the read image data in a HDD 307. Moreover, the control unit 301 can back up the image data in the HDD 307 to the external storage medium 102, and can restore the backup data from the external storage medium 102 to the HDD 307. Further, the control unit 301 can read and execute programs stored in the ROM 303 that control storage as illustrated in the flowcharts of FIGS. 12, 13, 14, and 15.

The RAM 302 is a work area of the control unit 301 and temporarily stores data.

The ROM 303 stores various programs read by the control unit 301, such as programs for controlling storage as illustrated in the flowcharts of FIGS. 12, 13, 14, and 15.

The control unit 301 performs control according to instruction received from a user via an operation unit 304 such as a hard key or a touch panel. The control unit 301 can receive a user instruction to back up or restore data via the operation unit 304, which will be described later. Further, the operation unit 304 can display a status of the image processing apparatus 101 or an error message on a touch panel unit (i.e., a display unit).

The printer unit 305 prints an image data on a recording medium conveyed from a paper feed unit (not illustrated), according to an instruction from the control unit 301.

The scanner unit 306 reads a document fed from an auto document feeder (ADF) or set on a platen glass and converts the document into an image data, according to an instruction from the control unit 301. If a user requests printing of an image data, the scanner unit 306 transfers the converted image data to the printer unit 305. Further, if a user requests storing of the data in the HDD 307, the scanner unit 306 transfers the converted image data to the HDD 307.

The HDD 307 is an auxiliary storage device for storing image data according to an instruction from the control unit 301, which will be described in detail later.

A NIC 308 performs interface control when the image processing apparatus 101 exchanges data via the network 105.

A digital service unit (DSU) 309 is used to connect the image processing apparatus 101 to a digital line 321 to send and receive data.

A network control unit (NCU) 311 connects the image processing apparatus 101 to an analog line 322, to open or close the line, control sending and receiving of data, and send and receive (analog) image data. A modem 310 modulates and demodulates the image data when the data is sent or received.

A timer 312 is used for time management. For example, if a data to which storage expiration is set is stored in the HDD 307 in association with storage expiration information, the control unit 301 determines whether the data has exceeded the storage expiration of the data, based on time information managed by the timer 312. If the control unit 301 determines that the data has exceeded the storage expiration, the control unit 301 deletes the data from the HDD 307. Moreover, if the control unit 301 determines that the data has exceeded the storage expiration, the control unit 301 can overwrite other data on the data. As described above, the control unit 301 can invalidate a data if the control unit 301 determines that the data has exceeded the storage expiration. Further, if the control unit 301 determines that the data has exceeded the storage expiration, the control unit 301 can make the data unreadable or inaccessible. Further, if the control unit 301 determines that the data has exceeded the storage expiration, the control unit 301 can make the data unprintable, non-transmittable, or unable to be displayed, or a combination of any of the above-described processes. Consequently, the control unit 301 can make the data unusable. In such a case, storage expiration information of a data refers to information about time from which the above-described processes cannot be performed on the data.

An external storage medium connecting unit 313 connects the external storage medium 102 to the image processing apparatus 101. The control unit 301 sends and receives data to and from the external storage medium 102 to which the control unit 301 is connected via the external storage medium connecting unit 313.

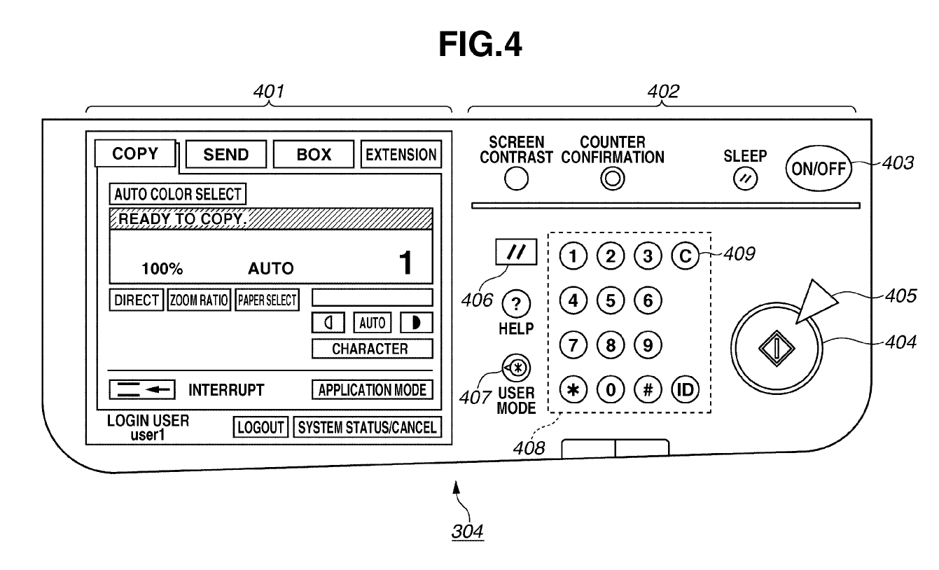

The operation unit 304 will be described below with reference to FIG. 4.

The operation unit 304 includes a touch panel unit 401 and a key input unit 402.

The touch panel unit 401 includes a touch panel display that is configured by an LCD covered with a transparent electrode. The touch panel unit 401 includes a function for receiving various settings input by an operator and a function for providing information to the operator. When the control unit 301 detects that a user has pressed a displayed key on the LCD, the control unit 301 performs a process according to the pressed displayed key. Examples of a screen displayed on the touch panel unit 401 will be described later.

The key input unit 402 includes an operation unit power switch 403. When a user presses the operation unit power switch 403, the control unit 301 selectively switches between a standby mode (i.e., a normal operation state) and a sleep mode (i.e., power saving state). The control unit 301 receives a user operation of the operation unit power switch 403 when the main power switch (not illustrated) which supplies power to the entire system is in an on-state.

A user presses a start key 404 to instruct the control unit 301 of the image processing apparatus 101 to perform a series of operations as a print job. Such a series of operations includes, for example, reading a document using the scanner unit 306 and printing the read document. Further, a user presses the start key 404 to instruct the control unit 301 to perform a data transmission job of transmitting image data stored in the HDD 307 to an external device via the NIC 308.

A user presses a stop key 405 to instruct the image forming apparatus 101 to cancel the received print.

A user presses a reset key 406 to instruct the image forming apparatus 101 to invalidate various settings made by the user and restore default setting values, when performing a print job.

A user mode key 407 displays a screen for allowing each user to make a system setting on the touch panel unit 401.

A user inputs numbers for making various settings through a numeric keypad 408. A user presses a clear key 409 to delete an input value such as a user ID or a password that the user inputs through the numeric keypad 408.

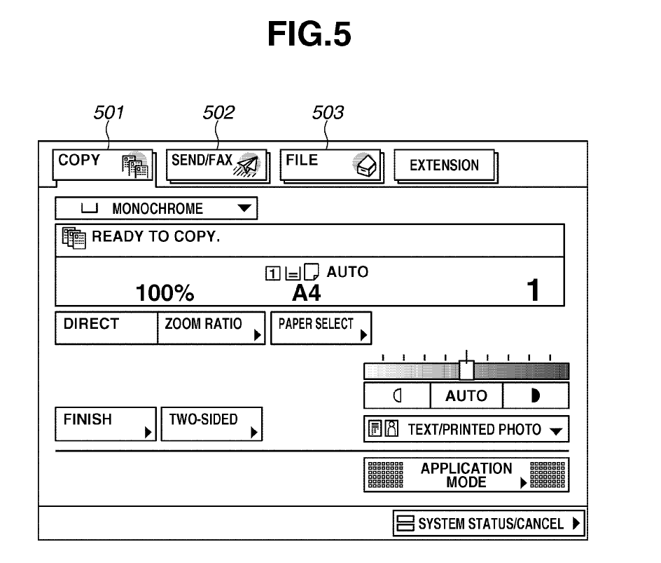

An example of a job setting screen displayed on the touch panel unit 401 will be described below with reference to FIG. 5. FIG. 5 illustrates a setting screen that is normally displayed on the touch panel unit 401 when the image processing unit 101 is switched on.

A user presses a copy key 501, and the control unit 301 displays a copy job setting screen on the touch panel unit 401 for a user to make a setting of a copy job. The screen illustrated in FIG. 5 is an example of the copy job setting screen. Through the copy job setting screen, the control unit 301 receives user settings as to a printing condition, e.g., number of printouts, type of printing paper, and print zoom ratio. If a user presses the start key 404 after the control unit 301 receives the settings, the control unit 301 reads a document using the scanner unit 306 and makes prints according to the set printing conditions in the printer unit 305.

When a user presses a send/fax key 502, the control unit 301 displays on the touch panel unit 401 a data transmission job setting screen for a user to make a setting concerning a data transmission function or a facsimile function included in the image processing apparatus 101.

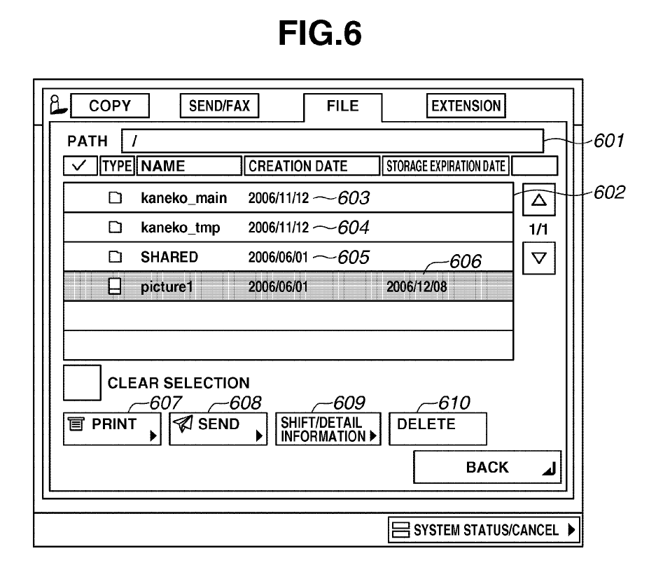

When a user presses a file key 503, the control unit 301 displays on the touch panel unit 401 a file processing function setting screen for a user to make a setting concerning a file processing function included in the image processing apparatus 101. FIG. 6 illustrates an example of a file processing function setting screen for a user to make a setting concerning a file processing function. A file processing function is a function performed by the control unit 301 to store image data read by the scanner 306 or received from an external source as a file in the HDD 307, and later print or transmit the image data according to a user instruction. The file processing function setting screen will be described below with reference to FIG. 6.

FIG. 6 illustrates an example of a display screen for making operations on an image data stored in the HDD 307. When a user presses the file key 503 on the job setting screen illustrated in FIG. 5, the control unit 301 displays the display screen illustrated in FIG. 6 on the touch panel unit 401.

A path name display area 601 is an area for displaying a file path. The control unit 301 displays a location of a folder or a file that is displayed in a file list display area 602, on the path name display area 601. Since the control unit 301 displays a folder or a file of the highest hierarchy level as a default, a “/” which indicates the highest hierarchy level is displayed in the path name display area 601.

The file list display area 602 is an area for displaying a list of files and folders storing a file that are targets for file processing. The control unit 301 displays “type”, “name”, “file creation date”, and “storage expiration” of each file or folder listed in the file list display area 602. “Type” indicates whether the corresponding line of data represents information about a folder or information about a file. “Name” is a file name or a folder name. “File creation date” is either the date on which an image data read by using the scanner unit 306 is registered as a file in the HDD 307, or the date on which an image data received from the client computer 103 is registered as a file in the HDD 307. Since the file creation date is the date on which the control unit 301 registered the file in the HDD 307, the date is also referred to as a file registration date.

“Storage expiration” is storage expiration that a user has previously set for each file. In the example of FIG. 6, the storage expiration is indicated as date information, i.e., “2006/12/08”. However, storage expiration can be set as storage period information and displayed as a number of days, such as “5 days”. For example, a user can set storage expiration to a file stored in the HDD 307 by designating a file and setting storage expiration through the operation unit 304. In such a case, the control unit 301 can set the storage expiration received from the user as the storage expiration of the file. Moreover, a user can set storage expiration to a folder through the operation unit 304. In this case, the control unit 301 sets the storage expiration received from the user through the operation unit 304 to the folder and can collectively set storage expirations to files inside the folder. Further, if the control unit 301 stores an image data that is newly sent from the scanner unit 306 or the client computer 103 as a file in the folder, the control unit 301 automatically sets storage expiration that is set to the folder, to the file to be stored. Therefore, a user can previously set storage expiration to a folder, so that the user does not need to set storage expiration to each file.

Lines 603, 604, and 605 in the file list display area 602 display information about a folder, and line 606 displays information about a file. The line 606 is shaded to indicate that a user has selected the file displayed in the line 606.

When a user presses a print key 607, the control unit 301 prints the selected file.

When a user presses a send key 608, the control unit 301 sends the selected file.

When a user presses a shift/detail information key 609, the control unit 301 displays on the touch panel unit 401 detailed information about the selected file. On the other hand, if a folder is selected, the control unit 301 displays on the touch panel unit 401 a list of folders or files inside the folder when a user presses the shift/detail information key 609.

When a user presses a delete key 610, the control unit 301 deletes the selected file.

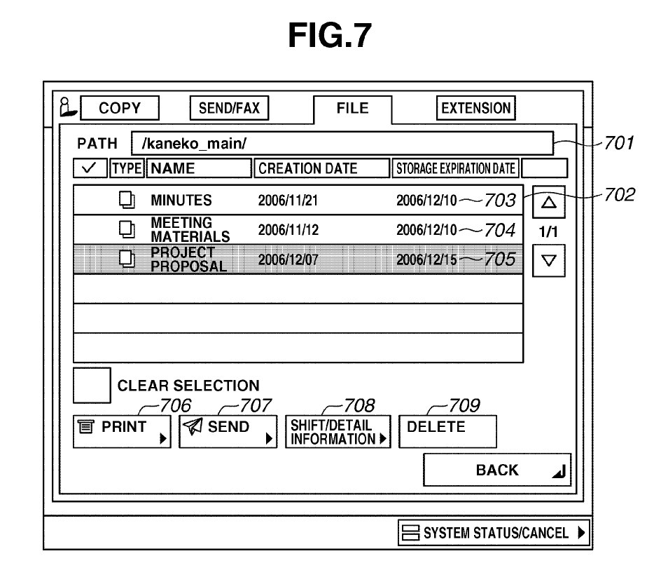

FIG. 7 illustrates a screen that the control unit 301 displays on the touch panel unit 401 when a user presses the shift/detail information key 609 while selecting “kaneko_main” folder indicated by line 603 in the file list display area 602 illustrated in FIG. 6.

A path name display area 701 is an area for displaying a file path of a file. The control unit 301 changes content displayed on the path name display area 701 when displaying a file in a folder or a folder.

In the illustrated example, storage expiration is set to a file instead of a folder. Consequently, storage expiration is not set to folders indicated in lines 603, 604, and 605, but storage expiration is set to files indicated by the line 606 illustrated in FIG. 6 and lines 703, 704, and 705 in a file list display area 702 illustrated in FIG. 7.

In the screen illustrated in FIG. 7, when a user selects a file from files displayed in the file list display area 702 and presses a print key 706, the control unit 301 prints the selected file. Moreover, if a user presses one of a send key 707, shift/detail information key 708, or a delete key 709 while selecting a file, the control unit 301 performs control similar to FIG. 6.

A user can use a file processing function through the file processing function setting screen illustrated in FIGS. 6 and 7. As a result, the user can store an image data that is read through a scanner or an image data received from an external source as a file in the HDD 307, and can later perform various operations on the stored file.

Processes for backing up or restoring a file stored in the HDD 307 to the external storage medium 102 or the server computer 104 will be described below.

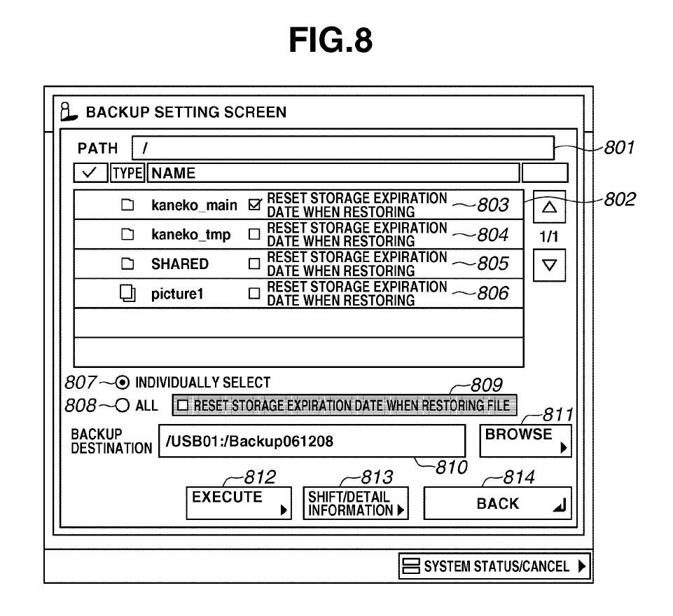

FIG. 8 illustrates a backup setting screen for receiving a setting or an instruction from a user in backing up a file. The screen is displayed when a user presses the user mode key 407 and performs a predetermined operation.

A path display area 801 is an area for displaying a file path of a file.

A file list display area 802 is an area in which the control unit 301 displays a list of files or folders to be backed up.

Radio buttons 807, 808 are used to select individually applying a setting of operation when restoring a file (i.e., a restore mode), or making a setting of operation when restoring a file, to all files to be backed up.

For example, if a user selects a “select individually” radio button 807, the control unit 301 displays restore mode selection buttons in lines 803, 804, 805, 806 in a selectable state. If a user selects one of the restore mode selection i.e., “reset storage expiration when restoring file”) buttons in the lines 803, 804, 805, 806 and performs a backup, the control unit 301 makes a setting concerning a file corresponding to the selected button, so that storage expiration is reset when restoring the file. The method for resetting the storage expiration will be described later.

On the other hand, if a user selects the “all” radio button 808, the control unit 301 displays “reset storage expiration when restoring file” button 809 in a selectable state. If a user then selects the “reset storage expiration when restoring file” button 809 and performs a backup, the control unit 301 makes a setting so that storage expirations of all files are reset when the files are restored. Moreover, if a user selects “all” radio button 808 and performs a backup without selecting the “reset storage expiration when restoring file” button 809, the control unit 301 makes a setting so that storage expiration of all files are not reset when the files are restored.

A backup destination input area 810 is an area for designating a backup destination. A user can press a browse key 811 to designate a backup destination. In the screen illustrated in FIG. 8, a setting is made to back up a selected file to a path (/Backup061208) of an external storage medium USB 01.

When a user presses an execute key 812, the control unit 301 starts a backup according to a condition set through the screen illustrated in FIG. 8.

If a user presses a shift/detail information key 813 while selecting a folder, the control unit 301 displays a list of folders or files inside the folder on the operation unit 304. Moreover, if the user presses the shift/detail information key 813 while selecting a file, the control unit 301 displays detailed information of the file on the operation unit 304.

When a user presses a back key 814, the control unit 301 stops displaying the backup setting screen, and, displays the screen illustrated in FIG. 5 on the touch panel unit 401.

If a user presses the execute key 812 while selecting line 803 that displays information about “kaneko_main” folder, the control unit 301 starts backing up of the data of folders and files in the folder. To be more specific, the control unit 301 transfers to a backup destination that is input in the backup input area 810, data of the files, attribute data of the files to be backed up, and hierarchy information of the folder. Examples of attribute data to be transferred are file name, file creation date, storage expiration, backup date, and restore mode information that indicates whether a setting is made to restore storage expiration when restoring a file.

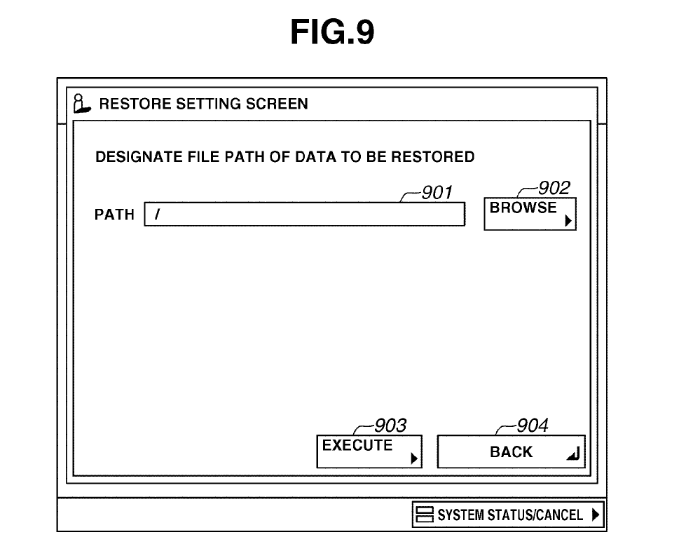

A setting screen for restoring a file that is backed up will be described below with reference to FIG. 9.

FIG. 9 illustrates a screen for making a setting to restore a file that is backed up in the external storage medium 102 or the server computer 104, to the HDD 307 of the image processing apparatus 101.

A path input area 901 is an area that displays a file path inside the external storage medium 102 or the server computer 104 in which there is a file to be restored. A user can input a file path using a browse key 902. In the example illustrated in FIG. 9, a user designates a backup data stored in a path (/Backup061208) of an external storage medium USB01 as data to be restored.

If a user presses an execute key 903 while designating a file path in the path input area 901, a backup data in the file path is restored by a method which will be described later. If a user presses a back key 904, the control unit 301 stops displaying a backup setting screen and displays the job setting screen illustrated in FIG. 5 on the touch panel unit 401.

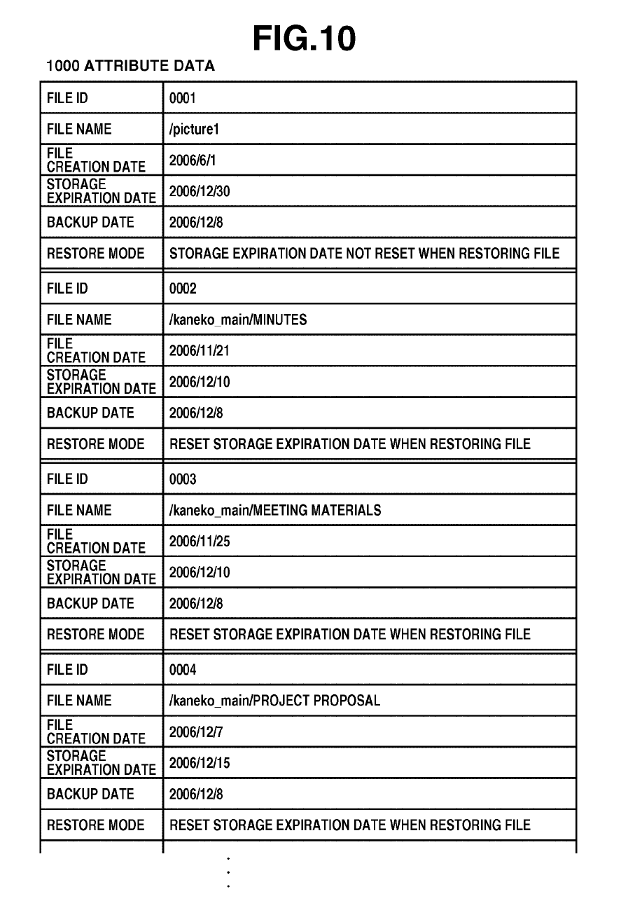

FIG. 10 illustrates an example of attribute data of files that the control unit 301 backs up when performing a backup process.

The control unit 301 uses “file ID”, “file creation date”, “storage expiration”, “backup date”, and “restore mode” as attribute data for each file.

“File ID” is an identification number (ID) that the control unit 301 assigns to each file to uniquely identify a file that is backed up.

“File name” is a name that a user sets to each file.

“File creation date” indicates the date and time when the file is created in the HDD 307 of the image processing apparatus 101.

“Storage expiration” indicates the expiration of storing the file in the HDD 307. The control unit 301 determines whether each file has exceeded the storage expiration, based on information from the timer 312, and deletes from the HDD 307 a file that has exceeded the storage expiration.

“Backup date” indicates the date and time when the file is backed up.

“Restore mode” is information indicating whether a backup is performed while a user selects a “reset storage expiration when restoring file” button 809 in the backup setting screen illustrated in FIG. 8.

For example, if a backup is performed while a user selects the “reset storage expiration when restoring file” button 809 in line 803 that indicates information about “kaneko_main” folder, the control unit 301 makes a setting so that storage expiration of files inside “kaneko_main” folder is reset when restoring the files. In such a case, the control unit 301 stores information which indicates that a setting is made to reset the storage expiration when restoring a file inside the “kaneko_main” folder, as illustrated in the attribute data of file ID0002, file ID0003, and file ID0004 in FIG. 10. On the other hand, if a restore mode setting button is not selected, such as in a case of “picture 1” file illustrated in FIG. 8, the control unit 301 makes a setting so that storage expiration is not reset when restoring the file.

In the present exemplary embodiment, “file creation date”, “storage expiration”, and “backup date” are managed as date information represented in terms of year, month, and date. However, “file creation date”, “storage expiration”, and “backup date” can also be managed in terms of hours and minutes. Date information is referred to also as time information.

A process executed by the control unit 301 when a user presses the “execute” key 812 on the backup setting screen will be described below with reference to a flowchart illustrated in FIG. 12.

In step S1201, the control unit 301 obtains file information stored in the HDD 307 which is a backup source. Examples of file information obtained by the control unit 301 include number of files to be backed up, file name, file creation date, file storage expiration, backup date, and setting information of a restore mode.

In step S1202, the control unit 301 creates attribute data for each file, as illustrated in FIG. 10, from information obtained in step S1201.

In step S1203, the control unit 301 backs up a file whose attribute data creation is completed, to a backup destination which is designated in the backup destination input area 810. Further, the control unit 301 backs up the created attribute data to the backup destination.

In step S1204, the control unit 301 determines whether there is a file in the HDD 307 that is not backed up. If it is determined that there is a file that is not backed up (YES in step S1204), the control unit 301 performs the process of step S1202 on the file. On the other hand, if the control unit 301 determines that there is no file in the HDD 307 that is not backed up (NO in step S1204), the control unit 301 ends the backup process.

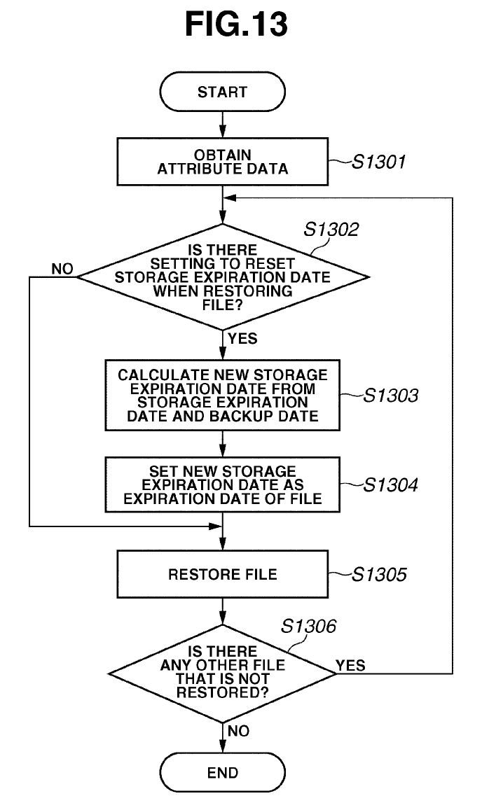

A process performed by the control unit 301 when a user presses the “execute” key 903 on the restore setting screen will be described below with reference to a flowchart illustrated in FIG. 13.

In step S1301, the control unit 301 obtains attribute data of a file that is stored in a backup destination by performing the process of step S1203 in the flowchart illustrated in FIG. 12. The control unit 301 then specifies the files to be restored from the obtained attribute data and performs processes described in steps S1302 to S1305 for each file.

In step S1302, the control unit 301 determines how a restore mode is set to a file that is included in the obtained file information. For example, the control unit 301 determines whether a setting is made to the file so that storage expiration is reset when restoring the file. If the control unit 301 determines that there is a setting to reset the storage expiration when restoring the file (YES in step S1302), the process proceeds to step S1303. On the other hand, if the control unit 301 determines that there is no setting to reset the storage expiration when restoring the file (NO in step S1302), the process proceeds to step S1305.

In step S1303, the control unit 301 calculates new storage expiration of the file based on a restore date (i.e., time and date at which a file is restored according to information from the timer 312), and on the storage expiration and the backup date included in the attribute data obtained in step S1301.

In the present exemplary embodiment, new storage expiration is calculated by the following equation.

<Equation for calculating new storage expiration>

(New storage expiration)=(restore date)+((storage expiration)−(backup date))

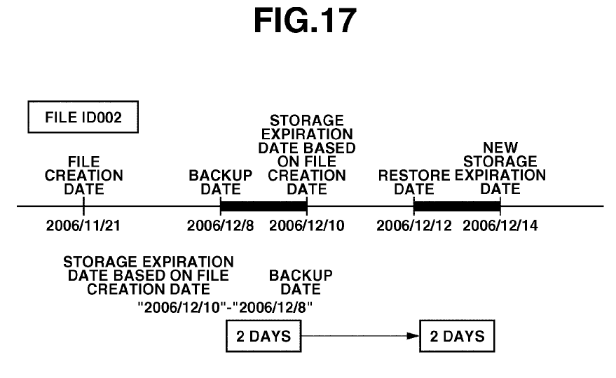

For example, the control unit 301 calculates new storage expiration using the above equation when restoring a file indicated by a file ID “0002” in FIG. 10, as described below. The new storage expiration is calculated with reference to FIG. 17. In the attribute data of the file indicated by file ID “0002”, “storage expiration” is 2006/12/10, a “backup date” is 2006/12/8, and a “restore date” is 2006/12/12. Therefore, the control unit 301 calculates “new storage expiration” as below.

New storage expiration=“2006/12/12”+(“2006/12/10″-“2006/12 8”)=“2006/12/14”

In step S1304, the control unit 301 sets the “new storage expiration” that the control unit 301 calculates in step S1303 as new storage expiration of the file. In step S1305, the control unit 301 ends the process of restoring the file.

In step S1306, the control unit 301 determines whether there is a file in the restore source that is not restored. If the control unit 301 determines that there is a file that is not restored (YES in step S1306), the process returns to step S1302. The control unit 301 then performs the processes of steps S1302 to S1305 on a file that is not restored. On the other hand, if the control unit 301 determines that there is no file that is not restored (NO in step S1306), the control unit 301 ends the restore process.

The control unit 301 deletes the file to which “new storage expiration” is set when the file exceeds the new storage expiration, starting from the date of restoring the file in the HDD 307.

In a case where a file is restored after a backup date and before exceeding storage expiration that is previously set by a user, the control unit 301 calculates “new storage expiration” by adding to the “restore date” the number of days between the “storage expiration” and the “backup date”. For example, if a file identified by file ID “002” is backed up on “2006/12/8” and restored on “2006/12/9”, a new storage date is calculated as below.

New storage date=“2006/12/09”+(“2006/12/10″−“2006/12/8”)=2006/12/11

The control unit 301 sets the “new storage expiration” that is calculated by the above equation to a file restored to the HDD 307 as new storage expiration. The control unit 301 deletes the file from the HDD 307 after the file exceeds the new storage expiration.

As described above, according to the first exemplary embodiment, when the control unit 301 backs up a file, the control unit 301 stores in a backup destination a file creation date and storage expiration, a backup date, and a restore mode of the file to be backed up. As a result, the control unit 301 can calculate “new storage expiration” from the “storage expiration”, the “backup date”, and the “restore date”, for a file in which a user selects a mode to reset the storage expiration when restoring the file. The control unit 301 can then reset the calculated “new storage expiration” as new storage expiration of the restored file.

The above-described control prevents deletion of a restored file in a case where the file has exceeded the storage expiration at the time of restoring. Further, the above-described control prevents storing of a restored file in the image processing apparatus 101 longer than necessary. As a result, storage expiration of a file can be appropriately managed in a case where a file to which storage expiration is set is backed up.

### Second Exemplary Embodiment

According to the first exemplary embodiment, when a file is backed up, file creation date, storage expiration, and back up data are stored as attribute date. New storage expiration of a file is calculated when restoring the file, based on the storage expiration and a backup date that are stored as attribute data, and a restore date.

In a second exemplary embodiment, when a file is backed up, a remaining storage period of a file is first calculated at the time of actually backing up the file, and is stored as attribute data of the file. New storage expiration is set to the file when restoring the file using the remaining storage period. Such a method will be described below.

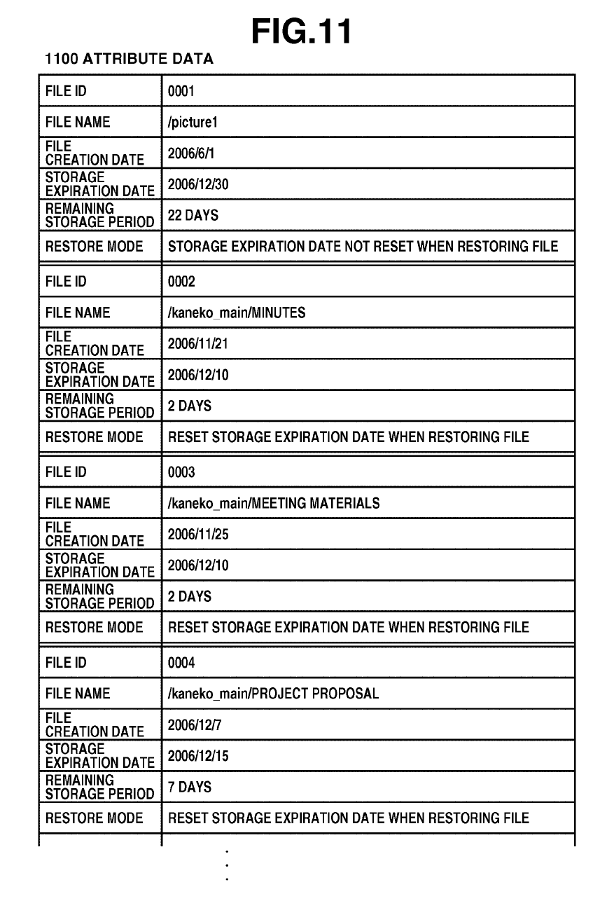

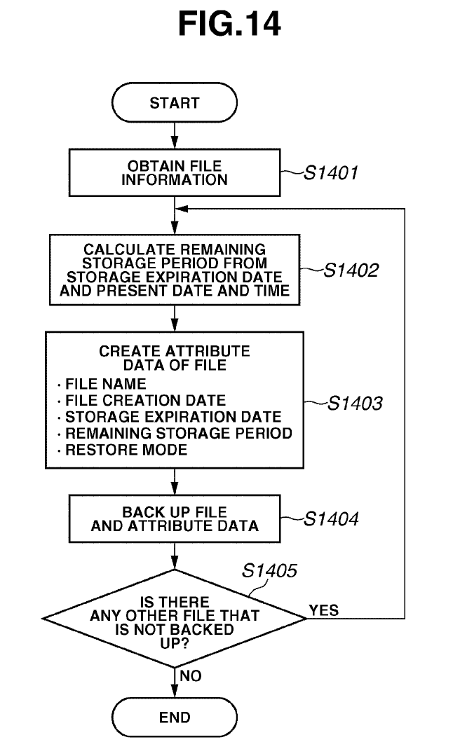

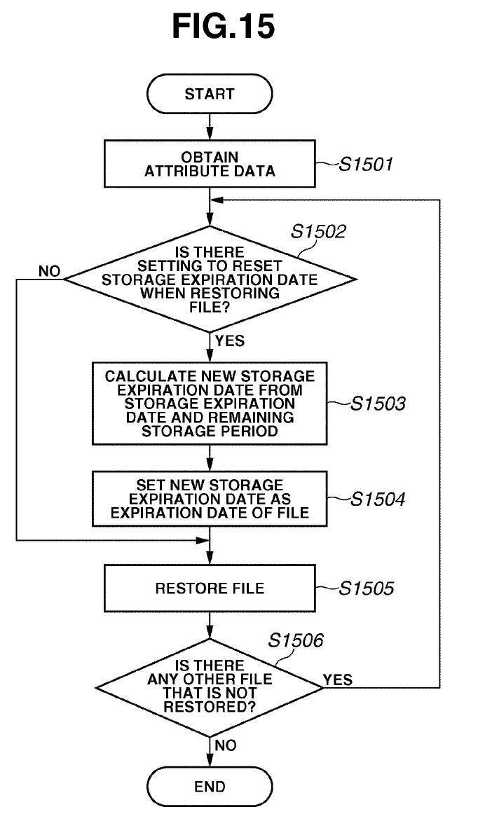

Since the second exemplary embodiment is similar to the first exemplary embodiment in the description with reference to FIGS. 1 to 9, description about the similar processes will be omitted, and the difference from the first exemplary embodiment will be described below. In particular, attribute data illustrated in FIG. 11, flowchart of a backup process illustrated in FIG. 14, and a flowchart of a restore process illustrated in FIG. 15 will be described below.

FIG. 11 is an example of attribute data of a file that the control unit 301 backs up when performing a backup process according to the present exemplary embodiment.

The control unit 301 uses “file ID”, “file name”, “storage expiration”, “remaining storage period”, and “restore mode” as attribute data for each file.

“File ID” is an ID that the control unit 301 assigns to each file to uniquely identify a file that is backed up.

“File name” is a name that a user sets to each file.

“File creation date” indicates the date and time that the file is created in the HDD 307 of the image processing apparatus 101.

“Storage expiration” indicates the expiration of storing the file in the HDD 307. The control unit 301 determines whether each file has exceeded the storage expiration, based on information from the timer 312, and deletes from the HDD 307 a file that has exceeded the storage expiration.

“Remaining storage period” refers to the amount of time, which shows how long a file can be stored from the backup date, calculated by a method to be described later.

“Restore mode” is information indicating whether a backup is performed while a user selects “reset storage expiration when restoring file” button in the backup setting screen illustrated in FIG. 8.

A process performed by the control unit 301 when a user presses the “execute” key 812 on the backup setting screen will be described, using the flowchart illustrated in FIG. 14.

In step S1401, the control unit 301 obtains information about a file stored in the HDD 307 which is a backup source. Examples of file information obtained by the control unit 301 are number of files to be backed up, file name, file creation date, storage expiration of a file, backup date, and restore mode.

In step S1402, the control unit 301 calculates a remaining storage period using storage expiration among information obtained in step S1401, and the present time and date.

Remaining storage period is calculated by the following equation.

<Equation for calculating remaining storage period>

Remaining storage period=(storage expiration)−(backup date)

New storage expiration for a file identified by a file ID “0002” illustrated in FIG. 11 is calculated using the above equation, as described below. If the “backup date” is “2006/12/8”, since the “storage expiration” is “2006/12/10”, the remaining storage period is obtained as follows. Remaining storage period=“2006/12/10”−“2006/12/8”=2 Therefore, the remaining storage period is 2 days.

In step S1403, the control unit 301 creates attribute data based on file name, file creation date, file storage expiration, and restore mode information that are obtained in step S1401, and the remaining storage period that is calculated in step S1402, as illustrated in FIG. 11.

In step S1404, the control unit 301 backs up a file whose attribute data creation is completed, to a backup destination which is designated in the backup destination input area 810. Further, the control unit 301 backs up the created attribute data to the backup destination.

In step S1405, the control unit 301 determines whether there is a file in the HDD 307 that is not backed up. If there is a file that is not backed up (YES in step S1405), the control unit 301 performs the process of step S1202 on the file. On the contrary, if the control unit 301 determines that there is no file in the HDD 307 that is not backed up (NO in step S1405), the control unit 301 ends the backup process.

A process performed by the control unit 301 when a user presses the “execute” key 903 on the restore setting screen will be described below with reference to a flowchart illustrated in FIG. 15.

In step S1501, the control unit 301 obtains attribute data that is stored in a backup destination, by performing the process of step S1404 in the flowchart illustrated in FIG. 14. The control unit 301 specifies the file to be restored from the obtained attribute data, and performs the processes of step S1502 to S1505 for each file.

In step S1502, the control unit 301 determines how a restore mode is set to a file included in the obtained file information. For example, the control unit 301 determines whether a setting is made to the file for resetting storage expiration when restoring the file. If the control unit 301 determines that a setting is made to the file for resetting storage expiration when restoring the file (YES in step S1502), the process proceeds to step S1503. On the other hand, if the control unit 301 determines that a setting is not made to the file for resetting storage expiration when restoring the file (NO in step S1502), the process proceeds to step S1505.

In step S1503, the control unit 301 calculates “new storage expiration” from “restore date” and “remaining storage period”.

In the present exemplary embodiment, “new storage expiration” can be calculated using the equation below. The equation will be described using a file identified by file ID “0002” included in the files illustrated in FIG. 11, to which a setting is made for resetting storage expiration when restoring the file.

<Equation for calculating new storage expiration>

(New storage expiration)=(restore date)+(remaining storage period)

Since the remaining storage period of the file identified by file ID “002” is “2 days”, if the “restore date” is “2006/12/12”, “new storage expiration” is calculated as below.

New storage expiration=“2006/12/12”+“2 days”=2006/12/14

In step S1504, the control unit 301 sets the calculated “new storage expiration” as new storage expiration of the file. In step S1505, the control unit 301 restores the file.

In step S1506, the control unit 301 determines whether there is a file other than the restored file that is not restored in the restore source. If the control unit 301 determines that there is a file that is not restored (YES in step S1506), the process returns to step S1502. The control unit 301 then performs the processes of steps S1502 to S1505 on files that are not restored. On the other hand, if the control unit 301 determines that there is no file that is not restored (NO in step S1506), the control unit 301 ends the restore process.

The control unit 301 deletes from the HDD 307 a file to which “new storage expiration” is set when the file exceeds the “new storage expiration” starting from the date the file is restored in the HDD 307.

As described above, according to the second exemplary embodiment, when the control unit 301 backs up a file, the control unit 301 calculates a “remaining storage period” of a file that is to be backed up, using the “storage expiration” and “backup date”. The control unit 301 then stores the “remaining storage period” in a backup destination as an attribute data of a file to be backed up. As a result, the control unit 301 can calculate “new storage expiration” when restoring a file, using the “restore date” and the “remaining storage period”. The control unit 301 can then reset the calculated “new storage expiration” as new storage expiration of the restored file.

The above-described control prevents deletion of a restored file in a case where the file has exceeded the storage expiration at the time of restoring. Further, the above-described control prevents storing of a restored file in the image processing apparatus 101 longer than necessary. As a result, storage expiration of a file can be appropriately managed in a case where a file to which storage expiration is set is backed up.

### Third Exemplary Embodiment

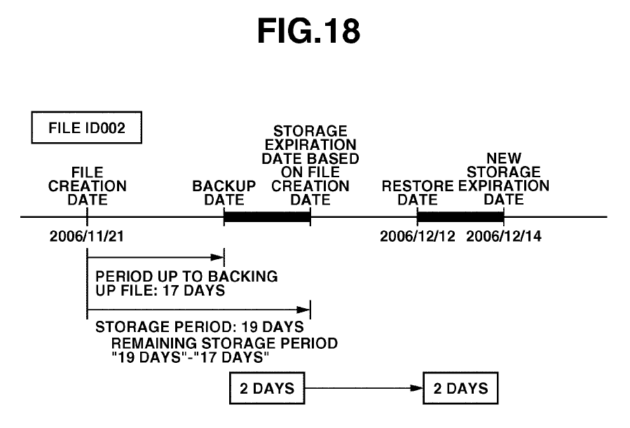

According to the above-described exemplary embodiments, the control unit 301 sets to a file stored in the HDD 307 storage expiration as date information such as “2006/12/10”. However, as illustrated in FIG. 18, the control unit 301 can set a time period, such as “19 days”, as storage period information about a file stored in the HDD 307, and store the storage period information associated with the file in the HDD 307. In such a case, the control unit 301 determines whether a storage period set to each file has elapsed, based on information from the timer 312. If the control unit 301 determines that the storage period set to a file has elapsed, the control unit 301 deletes the file from the HDD 307.

In the above-described case, suppose that the control unit 301 backs up the file whose storage period is “19 days” from the file creation date when “17 days” have elapsed from the file creation date. In such a case, the control unit 301 stores “2 days”, which is the difference between “19 days” and “17 days”, as storage expiration information in a backup destination associated with the file to be backed up. Therefore, the control unit 301 sets “2 days” as a storage period of the file when restoring the file, and deletes the file from the HDD 307 after 2 days have elapsed. As a result, when the control unit 301 backs up a file that is set to be deleted when the storage period elapses, even if the storage period elapses while the control unit 301 backs up the file, the user can use the file for the remaining storage period.

Moreover, a file can be managed using a storage period as described below. For example, the control unit 301 sets a storage period of “5 days” to a folder inside the HDD 307 according to a user instruction. As a result, the control unit 301 sets a storage period of “5 days” that is set to the folder, to a file stored in the folder. Consequently, the control unit 301 deletes the file stored in the folder from the HDD 307 after the storage period of “5 days” has passed from the date the file is stored in the HDD 307.

In the above-described case, suppose that the file is backed up after “2 days” have passed from the date the file is stored in the folder (i.e., the third day), and the file is restored after “5 days”, which is the original storage period. In that case, the control unit 301 resets a storage period of “5 days” set to the folder, to the file which is restored in the original folder, and deletes the file from the HDD 307 after 5 days have elapsed from the restore date. As a result, a user is given an opportunity to use the file.

However, in such a case, the storage period is extended every time a file is backed up or restored if a storage period of “5 days” is again reset to a file to be restored. Therefore, an improvement in file management is desirable. For example, if a file includes confidential information, it is not favorable to store the file in the HDD 307 for a long period of time in terms of security. Further, if a size of a file to be stored in the HDD 307 is large, it is not favorable to store the file in the HDD 307 for a long period of time. Consequently, a remaining storage period of “3 days” can be set as a storage period to the restored file instead of “5 days”, so that a file to which a storage period is set can be more appropriately managed when backing up the file.

### Other Exemplary Embodiments

According to the above-described exemplary embodiments, the image processing apparatus 101, which is a backup source, calculates a remaining storage period using a backup date and storage expiration that starts from a file creation date. However, an image processing apparatus which is a backup destination can calculate the remaining storage period. For example, the image processing apparatus 101 sends an image data to be backed up and data necessary for calculating the remaining storage period, to an apparatus which is the backup destination. The backup destination apparatus calculates the remaining storage period based on the data sent from the image processing apparatus 101. The backup destination apparatus then sends the calculated remaining storage period and the image data to be restored, to the image processing apparatus 101, i.e., the backup source. The image processing apparatus 101 can thus perform a series of control for deleting the file according to the received remaining storage period.

Moreover, in the above-described exemplary embodiments, there is a case where a user cannot directly perform an operation on a file stored in a backup destination, if the backup destination is the external storage medium 102, e.g., a USB memory or a CD-R. In such a case, a user cannot browse, print, or send (i.e., use) the file stored in the external storage medium 102. It is inconvenient for the user if the file exceeds storage expiration under such a condition. Consequently, when a file that is backed up is restored, new storage expiration is set to the file to provide a user with an opportunity to use the backed up file.

However, a backup destination is not always limited to the external storage medium 102, e.g., a USB memory or a CD-R, in which a user cannot directly perform an operation on the stored file. For example, a backup destination can be other image processing apparatus or the server computer 103, so that a user can directly perform the operation on the backed up file, such as browse, print, or send the file. In such a case, the control unit 301 does not extend the storage expiration when the file is restored. The file can be deleted when the file exceeds the storage expiration previously set by a user starting from the file creation date.

For example, when a user inputs a backup destination on a side of the image processing apparatus 101, the control unit 301 prompts the user to input information about whether the backup destination allows a user to browse, print or send the file. The control unit 301 then stores the input information as attribute data in the backup destination. When restoring the file, the control unit 301 references the attribute data received with the image data from the backup destination. If the control unit 301 determines that the backup destination is an external storage medium (or an apparatus) in which the file can be browsed, printed or sent, the control unit 301 does not reset the storage expiration. On the other hand, if the control unit 301 determines that the backup destination is an external storage medium (or an apparatus) in which the file cannot be browsed, printed or sent, the control unit 301 resets the storage expiration to the file when restoring a file stored in the backup destination. As a result, a period in which a user can use a file can be retained. Further, the file can be deleted after the period in which a user can use the file, passes, so that the storage expiration of the file can be more strictly managed.

Moreover, in the image processing apparatus 101 described in the first and second exemplary embodiments, a user cannot perform an operation on a file while the control unit 301 is backing up the file to which storage expiration is set. When the backed up file is restored, a user is then given the opportunity to use the file for a period of time the file has been backed up as described above. However, a user may be given the opportunity to use a file when a user is allowed to use a file, for a period of time the user could not use the file for reasons other than a backup, for example, due to file maintenance. In such a case, when the file maintenance is completed, the control unit 301 performs control to delete the file after a period equivalent to time between start of the maintenance and storage expiration passes that is previously set to the file in the HDD 307 starting from the date the maintenance is completed.

Further, the control unit 301 in the image processing apparatus 101 according to the above exemplary embodiments displays a screen on the touch panel unit 401. However, the touch panel unit 401 can uniquely include a control unit and a display memory. In such a case, the control unit 301 sends data to be displayed, to the display memory included in the touch panel unit 401, and a control unit of the touch panel 401 performs display according to the data to be displayed stored in the display memory.

According to the above-described exemplary embodiments, a job processing system (such as an image processing system) includes an information processing apparatus (i.e., image processing apparatus 101) and other apparatuses (i.e., client computer 103 and/or server computer 104). However, the job processing system (e.g., an image processing system) is not limited to the above configuration and can be singularly configured of an information processing apparatus (i.e., image processing apparatus 101).

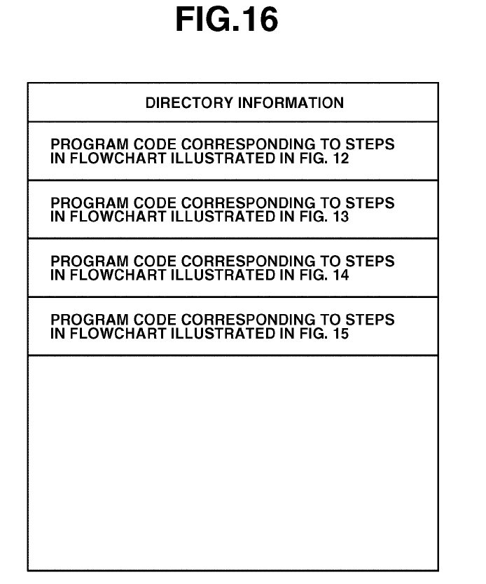

A data processing program which is readable by an image processing apparatus according to an exemplary embodiment of the present invention is described below, with reference to a memory map illustrated in FIG. 16.

FIG. 16 illustrates a memory map of a storage medium that stores various data processing programs that are readable by an image processing apparatus according to an exemplary embodiment of the present invention.

In addition, although not illustrated, information for managing software stored in the storage medium, for example, version or creator, and information relying on an operating system (OS) of a computer for reading out the software (e.g., programs, icon for identifying the programs, etc.) can be stored in the storage medium.

Furthermore, data ancillary to the various programs is managed in directories of the storage medium. In addition, programs for installing the various programs in computers or for decompressing compressed programs can be stored in the storage medium.

The control procedures illustrated in the flowcharts of FIG. 12 to FIG. 15 can be implemented by a host computer executing a program installed from an outside source. A group of information including a program can be supplied to an information processing apparatus from a storage device such as a compact disk-read-only memory (CD-ROM), flash memory, or floppy disk, or from an external storage device through a network.

The present invention can also be achieved by providing a storage medium, which stores software (program code) for realizing the operations of the above-described exemplary embodiments, to a system or an apparatus. The program code stored in the storage medium can be read and executed by a computer (central processing unit (CPU) or micro-processing unit (MPU)) of the system or the apparatus.

In this case, the software (program code) itself realizes the operations of the embodiments. The software (program code) itself and the storage medium, which stores the software (program code), constitute the present invention.

Such software (program code) can take any form, for example, object code, a program executed by an interpreter, or script data supplied to an OS.

The storage medium can be, for example, a Floppy® disk, a hard disk, an optical disk, a magneto-optical disk, a compact disc-read-only memory (CD-ROM), a CD-recordable (CD-R), a CD-rewritable (CD-RW), a digital versatile disk-ROM (DVD-ROM), a magnetic tape, a nonvolatile memory card, a ROM, or a DVD.

Such software (program code) can also be supplied by the system or the apparatus accessing a web page on the Internet through the browser of the client computer 103. The software (program code) itself or a compressed file including an auto-install function can be downloaded from the web page onto a hard disk. In addition, the program code can be broken up into a plurality of files, and each file can be downloaded from different web pages. Namely, the present invention can be applied to WWW or a ftp server that allows numerous users to download the program files so that the functions or processes of the present invention can be realized on their computers.

Furthermore, such software (program code) can be encrypted and stored in a storage medium such as a CD-ROM to be distributed to users. A user who meets the determining conditions can download the key information for decrypting the program from a web page through the Internet. By using the key information, the encrypted program can be executed and installed in a computer to realize the functions of the present invention.

Furthermore, the above-described exemplary embodiments can be not only realized by executing software (program code) read by a CPU. An OS or the like working on a computer can also perform a part or the whole of processes according to instructions of the software (program code) and realize functions of the above-described exemplary embodiments.

Furthermore, software (program code) read from a storage medium can be stored in a memory equipped in a function expansion board inserted in a computer or a function expansion unit connected to a computer, and a CPU in the function expansion board or the function expansion unit can execute all or part of the processing based on the instructions of the software (program code) to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-068791 filed Mar. 16, 2007, which is hereby incorporated by reference herein in its entirety.

What is claimed is:

1. An apparatus comprising:
a control unit configured to invalidate data stored in a first storage unit based on storage expiration information of the data; and
a memory control unit configured to selectively perform a first process for storing data read from the first storage unit in a second storage unit, and a second process for storing the data stored in the second storage unit by the first process, in the first storage unit,
wherein the control unit invalidates the data stored in the first storage unit based on a predetermined period from performance of the first process to a storage expiration indicated by the storage expiration information, in a case where data stored in the second storage unit by the first process is stored in the first storage unit by the second process.

2. An apparatus according to claim 1, wherein the control unit invalidates the data after a lapse of the predetermined period starting on a time when the second process is performed, in a case where the data stored in the second storage unit by the first process is stored in the first storage unit by the second process.

3. An apparatus according to claim 2, wherein the control unit calculates the predetermined period based on the storage expiration and a time when the first process is performed, in a case where the data stored in the second storage unit by the first process is stored in the first storage unit by the second process.

4. An apparatus according to claim 2, wherein the control unit calculates the predetermined period based on the storage expiration and a period from storing of the data in the first storage unit to performance of the first process, in a case where the data stored in the second storage unit by the first process is stored in the first storage unit by the second process.

5. An apparatus according to claim 1, further comprising a selecting unit configured to select one of a first mode and a second mode,
the first mode being that the control unit invalidates the data stored in the first storage unit, based on the predetermined period, in a case where the data stored in the second storage unit by the first process is stored in the first storage unit by the second process, and,
the second mode being that the control unit invalidates the data stored in the first storage unit, based on storage expiration information of the data, in a case where the data stored in the second storage unit by the first process is stored in the first storage unit by the second process.

6. An apparatus according to claim 5, wherein the first storage unit stores the data in association with a folder;
wherein the selecting unit can select one of the first mode or the second mode for each of the folder;
wherein the control unit performs a process according to the first mode for the data stored in association with the folder in a case where the first mode is selected for the folder, and
wherein the control unit performs a process according to the second mode for the data stored in association with the folder in a case where the second mode is selected for the folder.

7. An apparatus according to claim 1, wherein the first storage unit stores the data in association with a folder;
wherein the storage expiration information is set for each of the folders, and
wherein the control unit invalidates the data stored in association with the folder based on the storage expiration information set to the folder.

8. An apparatus according to claim 1, wherein the second storage unit comprises an external storage device for backing up data stored in the first storage unit.

9. An apparatus according to claim 1, wherein the control unit invalidates data stored in the first storage unit by deleting the data from the first storage unit.

10. A method comprising:
selectively performing a first process for storing data read from a first storage unit into a second storage unit, and a second process for storing data stored in the second storage unit by the first process, in the first storage unit; and
invalidating the data stored in a first storage unit by the second process based on a predetermined period from performance of the first process to storage expiration indicated by the storage expiration information previously set to the data read out by the first process, in a case where the data stored in the second storage unit by the first process is stored in the first storage unit by the second process.

11. A method according to claim 10, wherein the data is invalidated after a lapse of the predetermined period starting on a time when the second process is performed, in a case where the data stored in the second storage unit by the first process is stored in the first storage unit by the second process.

12. A method according to claim 11, wherein the predetermined period is calculated based on the storage expiration and a time when the first process is performed, in a case where the data stored in the second storage unit by the first process is stored in the first storage unit by the second process.

13. A method according to claim 11, wherein the predetermined period is calculated based on the storage expiration and a period from storing of the data in the first storage unit to performance of the first process, in a case where the data stored in the second storage unit by the first process is stored in the first storage unit by the second process.

14. A method according to claim 10, further comprising:
selecting one of a first mode and a second mode,
a first mode being that the data stored in the first storage unit is invalidated, based on the predetermined period, in a case where a data stored in the second storage unit by the first process is stored in the first storage unit by the second process, and,
a second mode being that the data stored in the first storage unit is invalidated, based on storage expiration information of the data, in a case where the data stored in the second storage unit by the first process is stored in the first storage unit by the second process.

15. A method according to claim 14, wherein the first storage unit stores the data in association with a folder;
wherein a process according to the first mode is performed for the data stored in association with the folder, in a case where a selecting unit which selects one of the first mode or the second mode for each folder, selects the first mode for the folder, and
wherein a process according to the second mode is performed for the a data stored in association with the folder, in a case where a selecting unit which selects one of the first mode or the second mode for each folder, selects the second mode for the folder.

16. A method according to claim 10, wherein the first storage unit stores the data in association with a folder;
wherein the storage expiration information is set for each of the folders, and
wherein the data stored in association with the folder is invalidated, based on storage expiration information set to the folder.

17. A method according to claim 10, wherein the second storage unit comprises an external storage device for backing up data stored in the first storage unit.

18. A method according to claim 10, wherein invalidating the data stored in the first storage unit comprises deleting the data from the first storage unit.

19. A computer-readable storage medium that stores a program for causing an apparatus to execute a method for controlling the apparatus, a program comprising:
a code to selectively perform a first process for storing data read from a first storage unit in a second storage unit, and a second process for storing the data stored in the second storage unit by the first process, in the first storage unit; and
a code to invalidate the data stored in the first storage unit by the second process based on a predetermined period from performance of the first process to a storage expiration indicated by the storage expiration information previously set to the data read out by the first process, in a case where a data stored in the second storage unit by the first process is stored in the first storage unit by the second process.
